(19) United States
(12) Patent Application Publication
(10) Pub. No.: US 2023/0296433 A1
(43) Pub. Date: Sep. 21, 2023

(54) OPTICAL SPECTROMETER BASED ON ALTERNATING DIFFRACTIVE OPTICAL ELEMENTS

(71) Applicant: ORTA DOGU TEKNIK UNIVERSITESI, Ankara (TR)

(72) Inventors: Emre YUCE, Ankara (TR); Alim YOLALMAZ, Ankara (TR); Cagdas Anil YUKSEL, Ankara (TR)

(73) Assignee: ORTA DOGU TEKNIK UNIVERSITESI, Ankara (TR)

(21) Appl. No.: 18/004,452

(22) PCT Filed: May 27, 2021
(86) PCT No.: PCT/TR2021/050499

§ 371 Date: Jan. 6, 2023

(30) Foreign Application Priority Data
Jul. 6, 2020 (TR) 2020/10646

(51) Int. Cl. G01J 3/02; G02B 23/06

(52) U.S. Cl. CPC G01J 3/0202; G01J 3/0208; G01J 3/0224; G01J 3/0237; G02B 23/06; G01J 3/42

(57) ABSTRACT

A high-resolution optical spectrometer with multiple diffractive optical elements operates under broadband light and enables spectral splitting with 3D diffractive optical elements. Diffractive optical elements are used to provide concentration of light as well as spectral splitting. Depending on the application, the high-resolution optical spectrometer operates with a reflection or transmission diffractive optical element. The number of operating wavelengths, spectral resolution, and operating bandwidth of diffractive optical elements are flexible depending on application.

### CROSS REFERENCES TO THE RELATED APPLICATIONS

This application is the national phase entry of International Application No. PCT/TR2021/050499, filed on May 27, 2021, which is based upon and claims priority to Patent Applications No. TR 2020/10646, filed on Jul. 06, 2020, the entire contents of which are incorporated herein by reference.

### TECHNICAL FIELD

The invention presents optical spectrometers based on alternating diffractive optical elements which performs spectrum analysis with high spectral resolution.

### BACKGROUND

Measurement of both quantitative absolute concentrations and frequency-dependent cross-sectional areas of atoms and molecules by absorption, transmission, and reflection spectroscopy techniques is of great importance for many fields especially analytical and physical chemistry. Optical spectrometers are widely used essentially in optical identification of materials, chemical analysis, security applications, astronomical sample identification, and biomedical diagnostic. The use of optical spectrometers is increasing with our scientific and technological developments, and the need for portable optical spectrometers with higher performance, low-weight, and small volume is of utmost importance. Also, high accurate spectrometers are needed for a trace amount of sample/analyte detection.

Atomic emission spectrometer, a type of spectrometer used in analysis of an inorganic sample accommodates inductively coupled plasma as a light source. The sample exposed to plasma radiates light, and the light that comes out for analysis of spectral behavior of the sample is dispersed into spectrum of the light. Multiple reflection diffractive gratings are used for spectral separation, so volume and weight of the spectrometer increase.

In absorption spectroscopy, while absorption of light by a sample is measured at a certain frequency with a monochromatic light source, the absorption light by the sample can also be measured by separating broadband light spectrum into wavelength components. Light sources and detectors, whose dimensions and production costs have decreased with technological developments, allow installation of compact and portable optical spectrometers. However, the costs of these devices are still not in a situation that a consumer can afford.

The diffraction gratings used in conventional spectrometers have a regular and repetitive structure. These diffraction gratings operate in a narrow light band. In addition, the fact that the number of photons reflected from a diffraction grating is on the order of 30%, causes few photons to interact with a sample in an optical spectrometer. Thus, minimum amount of sample/analyte that an optical spectrometer can measure is high, and a trace amount of sample measurement is not possible. In addition, surface of the diffraction gratings, which needs a sudden change makes production difficult and increases production cost.

### SUMMARY

The diffraction gratings used in conventional spectrometers have a regular and repetitive structure. These diffraction gratings operate in a narrow light band. Diffractive optical elements (DOEs) used for similar purposes are optical guider and focuser whose micron-sized depth changes spatially. However, unlike diffraction gratings, diffractive optical elements operate in a wider light band, and their structure is not repetitive. The structure of diffractive optical elements is calculated according to their functions and purposes. Diffractive optical element, or diffractive optical elements, perform the functions that a lens and a diffraction grating perform together. A drawing of a sample diffractive optical element is given in FIG. 1.a. FIG. 1.b shows how a diffraction pattern forms on a screen by using a diffractive optical element. After incident light passes through the diffractive optical element, the DOE creates an image on the screen. Image seen on each pixel of the screen is obtained by contribution of all incident light to that pixel on the screen. This image acquired on the screen is strongly affected by path length difference of all incident light to each pixel on the screen. Thus, the separation of diffracted light and dispersion of the light into wavelength components are obtained. Although a DOE looks similar to a Bragg reflection grating, which creates an image on the screen by using a different physical phenomenon, a Bragg reflection grating has a 1 dimensional spatially thickness change and provides only wavelength separation due to the fact that the light reflected from layers of the Bragg grating has a specific wavelength. A high concentration of light is achieved by using a diffractive optical element that is lighter and smaller compared to conventional lenses. A diffractive optical element can perform the functions of an optical lens and a diffraction grating alone, or even functions they perform together. In addition, compactness of a diffractive optical element provides a great advantage in these works.

With this invention, optical spectrometer designs performing spectral splitting of broadband light are proposed. In addition, the optical spectrometer designs, which can use more than 70% of photons, a lower minimum sample/analyte amount can be measured, and a trace amount of sample measurement is now possible. Furthermore, the cost of optical spectrometers, whose designs are given here, is low compared to conventional spectrometers due to the fact that fewer optical items are used. Besides, these designs are compact, portable, have small volume and weight. These designs may be integrated into mobile phones, computers, tablets and etc., so that optical spectrum can be measured everywhere. Toxic, explosive, and flammable chemicals can be detected everywhere with these compact optical spectrometer designs. These advantages in particular allow instant detection of toxic, flammable, and explosive chemicals to be carried out on mobile.

With this work, optical spectrometers with diffractive optical elements designed for each wavelength and placed in a moving part, are proposed. Compared to optical spectrometers constructed with a single prism or diffraction grating and operating in a narrow light band, these spectrometer designs can operate with broadband light. Besides, a decrease in the number of photons seen in a prism and diffraction grating is reduced/eliminated by this invention. In addition to increasing the number of photons, a high signal/noise ratio can be obtained with this invention, and sample detection and identification can be carried out in a shorter time. The diffractive optical elements provide spectral splitting as well as concentration of light. With this feature, our invention reduces the need for optical elements (lens, etc.) for focusing.

### BRIEF DESCRIPTION OF THE DRAWINGS

Figures prepared for a better understanding of optical spectrometers that contains diffractive optical elements and are capable of high-resolution spectrum separation developed with this invention are described below.

FIG. 1a: Spatial thickness distribution of a sample diffractive optical element.

FIG. 1b: Drawing for formation of a diffraction pattern.

FIG. 2: Drawing for interaction of incident light with transmission and reflection diffractive optical elements.

FIG. 3: Diagram for the most general accommodation of diffractive optical elements in an optical spectrometer.

FIG. 4: Drawing of the spectrometer setup consisting of transmission diffractive optical elements located on a rotating table.

FIG. 5: Drawing of the spectrometer setup consisting of reflection diffractive optical elements located on a rotating table.

FIG. 6: Drawing of the spectrometer setup consisting of transmission diffractive optical elements located on a linear moving table.

FIG. 7: Drawing of the spectrometer setup consisting of reflection diffractive optical elements located on a linear moving table.

FIG. 8: Drawing of the spectrometer setup consisting of transmission diffractive optical elements located on a rotating table and a camera.

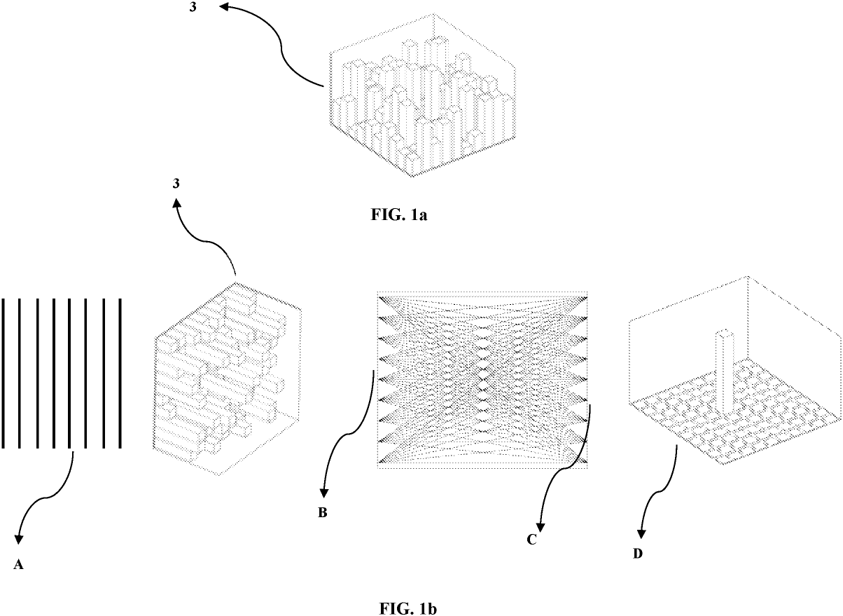

### DEFINITIONS OF THE ELEMENTS/PARTS/PIECES FORMING THE INVENTION

Pieces/parts/elements in the figures prepared for a better understanding of optical spectrometers that contain diffractive optical elements and have capable of a high-resolution spectrum separation are individually numbered, and the explanation of each number is given below.
1. Light Source
2. Focusing and Guiding Optical Elements
3. Diffractive Optical Element
4. Detector
5. Data Collection and Controller
6. Entrance optical Elements
7. Moving Part
A = Incident light
B = Formation of a Image on a screen
C = Screen
D = Diffraction pattern formed on a Screen

### DETAILED DESCRIPTION OF THE EMBODIMENTS

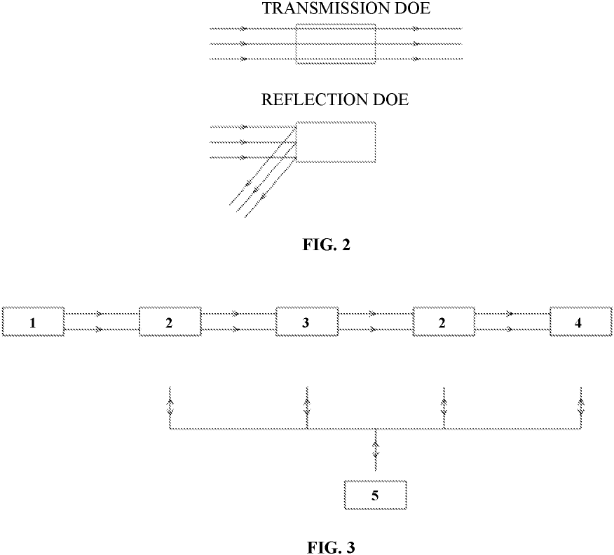

Diffractive optical elements can be designed with many algorithms and mathematical tools in a computer environment or by measuring experimentally. These designs can be for focusing broadband incident light on a point, focusing different wavelengths of light on different points, or focusing incident single-wavelength light to a specified point. Diffractive optical elements can be fabricated with many materials. Depending on application, reflection or transmission diffractive optical elements can be fabricated. Transmission and reflection of the light directed to the diffractive optical elements are shown in FIG. 2. Diffractive optical elements control spatial and spectral information of light with their spatially varying thickness distribution.

Considerations for designing diffractive optical elements are the path length difference where light propagates from a diffractive optical element to a target screen or detector, operating wavelength or wavelength range, pixel size of the diffractive optical element, a refractive index of diffractive optical element material at operating wavelength, and spatially varying thickness distribution. After determining the aforementioned parameters depending on application, diffractive optical elements are fabricated. This invention includes many spectrometer designs comprising diffractive optical elements and methods for high-resolution spectrum measurement. With integration of diffractive optical elements, a low-cost optical spectrometer device with high accuracy and resolution is the most important output of this invention. These designs, which use photons with especially high throughput, provide detection of a trace amount of chemical/biological/mechanical sample. Ordinary optical spectrometers used by consumers and scientists are not only bulky and heavy but also costly.

With this invention, spectrometers with a small volume and high spectral resolution are developed at a lower cost. With the methods we have developed, it is possible to turn mobile phones and computers into optical spectrometers. In this way, consumers can use the developed spectrometers in situations that require analysis on mobile. For example, it may be able to test authenticity and purity of purchased products (food ingredients) and even detect a specific molecule sought in a blood sample. In addition to these examples, detection of the hCG molecule used in diagnosis of pregnancy can be performed quickly.

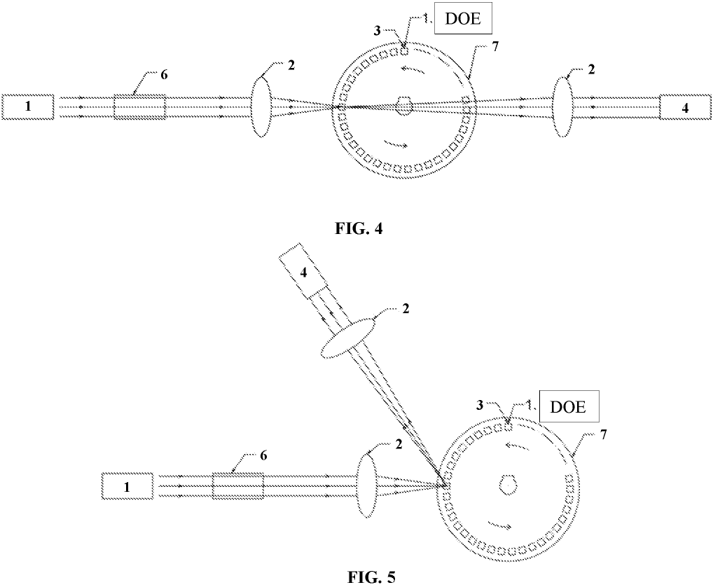

In this invention, we present optical spectrometers for dispersion of light spectrum with a high spectral resolution by using the diffractive optical elements determined for each wavelength. The diffractive optical elements calculated for each wavelength allow to concentration of the light at a targeted wavelength on a detector, and the incident light intensity at this wavelength is measured by a detector or CCD camera. For other wavelengths, different diffractive optical elements are used. Wavelength-dependent light intensity is measured by changing the diffractive optical elements, which are specially designed for each wavelength, respectively. FIG. 3 shows the general optical spectrometer setup with different diffractive optical elements. As shown in FIG. 3, the spectrometer consists of components that analyze the incident light from the light source (1). Incident light can be sunlight, laser, fiber laser, vertical-cavity surface-emitting laser (VCSEL), LED, bulb, and lamp. Additionally, the incident light can be reflected and transmitted light from a sample. The spectrum of incident light can be in ultraviolet, visible, and infrared region of the electromagnetic spectrum, and the incident light can be pulsed and continuous. The beam from the light source (1) passes through entrance optical elements (6) and a series of focusing and guiding optical elements (2), and the beam is adjusted for proper operation of the optical spectrometer. The entrance optical elements (6) can be iris, objective, lens, mirror, telescope, aperture, polarizer, Glan-Thomson prism, quarter-phase plate, and half-phase plate. Afterward, the beam coming to the reflection or transmission diffractive optical element (3) reflects or transmits. The diffractive optical elements (3) can be fabricated from metal, semiconductor, insulator, polymer, and a combination of these materials. The diffractive optical elements (3) are positioned in a moving part (7). The moving part (7) can be a rotating or linear moving table. The beam after the diffractive optical elements (3) reaches again to the detector (4) after passing through the optical guider and collector (2). The detector (4) can be a photodetector, avalanche photodetector, photomultiplier tube, CCD camera, CMOS camera, and line array photodiodes. The spectrum sensitivity of these photodiodes can be in ultraviolet, visible, and infrared regions of the electromagnetic spectrum. As specified in FIG. 3, data collection and controller (5) are grouped with a collection of focusing and guiding optical elements (2), diffractive optical elements (3), and detector (4).

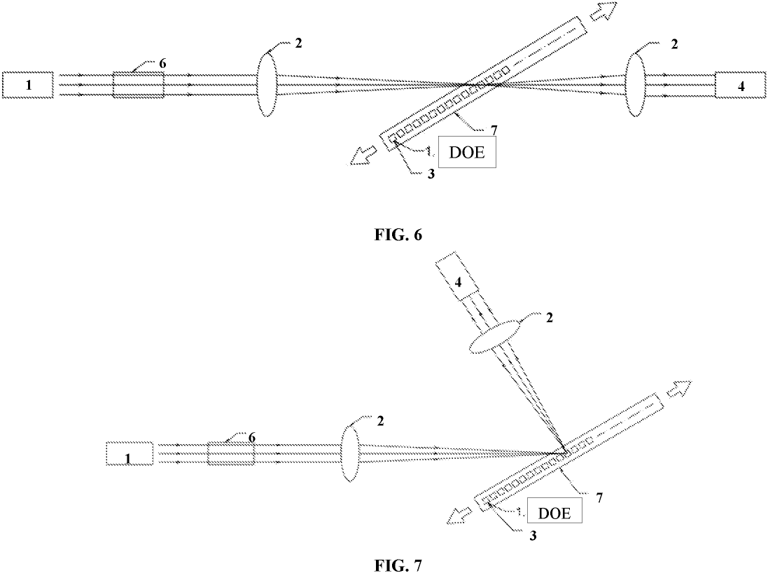

The broadband light spectrum is dispersed by using diffractive optical elements (3) designed for individual wavelength. For this aim, a high resolution and fast optical spectrum is obtained by positioning the diffractive optical elements (3) on a moving part (7) and changing them quickly. Thanks to the moving parts (7) used, alternation of diffractive optical elements (3) is easily achieved. FIG. 4, FIG. 5, FIG. 6, and FIG. 7 include optical spectrometer drawings established by positioning transmission and reflection diffractive optical elements (3) on moving parts (7) which are rotating and linear moving tables.

The components that constitute FIG. 4 are the light beam from the light source (1), the entrance optical elements (6), the focusing and guiding optical elements (2), the transmission diffractive optical elements (3) designed for each wavelength placed on the moving part (7) in the form of a rotating table, and a detector (4). The light beam from the light source (1) can be the sunlight, laser, fiber laser, vertical-cavity surface-emitting laser (VCSEL), LED, bulb, and lamp. Additionally, the incident light can be reflected and transmitted light from a sample. The spectrum of incident light can be in ultraviolet, visible, and infrared regions of the electromagnetic spectrum, and the incident light can be pulsed and continuous. The entrance optical elements (6) can be iris, objective, lens, mirror, telescope, aperture, polarizer, Glan-Thomson prism, a quarter-wave plate, and a half-wave plate. The focusing and guiding optical elements (2) can be a meta-lens, positive lens, Fresnel lens, spherical lens, cylindrical lens, dichroic mirror, concave mirror, convex mirror, fiber optic cable, diffractive optical element, and prism. Then the incident light beam passes to the transmission diffractive optical elements (3). The diffractive optical elements (3) are positioned on the rotating table in motion. The mechanisms that enable the movement of the rotating table where the diffractive optical elements (3) are placed can be four-bar linkage and slider-crank mechanisms. Also, rotational movement can be provided by a step motor and piezo. The diffractive optical elements (3) can be fabricated from semiconductors, insulators, metals, polymers, and a combination of these materials. The incident light beam transmitted through the diffractive optical elements (3) reaches the focusing and guiding optical elements (2) again. The incident light beam reaching the focusing and guiding optical elements is directed to the detector (4). The use of focusing and guiding optical elements (2) after diffractive optical elements (3) is additional equipment offered to increase wavelength resolution and accuracy. Depending on the design, diffractive optical elements (3) take on the task of equipment numbered 2 and 6. Depending on the light intensity and device dimensions, the focusing and guiding optical elements (2) and entrance optical elements (6) may not be used. The detector (4) can be a photodetector operating in different spectra, avalanche photodetector, photomultiplier tube, CCD camera, CMOS camera, and line array photodiodes.

The components that constitute FIG. 5 are the light beam from the light source (1), the entrance optical elements (6), the focusing and guiding optical elements (2), reflection diffractive optical elements placed on the rotating table and designed for each wavelength (3) and a detector (4). The light beam from the light source (1) can be the sunlight, laser, fiber laser, vertical-cavity surface-emitting laser (VCSEL), LED, bulb, lamp. Additionally, the incident light can be reflected and transmitted light from a sample. The spectrum of incident light can be in ultraviolet, visible, and infrared regions of the electromagnetic spectrum, and the incident light can be pulsed and continuous. The entrance optical elements (6) can be an iris, objective, mirror, telescope, aperture, lens, polarizer, Glan-Thomson prism, quarter-wave plate, and half-wave plate. The focusing and guiding optical elements (2) can be a meta-lens, positive lens, Fresnel lens, spherical lens, cylindrical lens, dichroic mirror, concave mirror, convex mirror, fiber optic cable, diffractive optical element, and prism. Then the incident light beam reflects from the reflection diffractive optical elements (3). The diffractive optical elements (3) are positioned on the rotating table in motion. The mechanisms that enable the movement of the rotating table, which is the moving part (7), where the diffractive optical elements (3) are placed can be four-bar linkage and slider-crank mechanisms. Also, rotational movement can be provided by a step motor and piezo. The diffractive optical elements (3) can be fabricated from metals, semiconductors, insulators, polymers, and a combination of these materials. The incident light beam reflected from the diffractive optical elements (3) reaches the focusing and guiding optical elements (2) again. The incident light beam reaching the focusing and guiding optical elements (2) is directed to the detector (4). The use of focusing and guiding optical elements (2) after diffractive optical elements (3) is additional equipment provided to further increase the spectral resolution of the spectrometer. Depending on the design, diffractive optical elements (3) take on the task of equipment numbered 2 and 6. Depending on the light intensity and device dimensions, the focusing and guiding optical elements (2) and entrance optical elements (6) may not be used. The detector (4) can be a photodetector operating in different spectra, avalanche photodetector, photomultiplier tube, CCD camera, CMOS camera, and line array photodiodes.

The components mentioned in FIG. 6 are the light beam from the light source (1), the entrance optical elements (6), the focusing and guiding optical elements (2), transmission diffractive optical elements placed on the linear moving table and designed for each wavelength (3) and a detector (4). The incident light beam can be the sunlight, laser, fiber laser, vertical-cavity surface-emitting laser (VCSEL), LED, bulb, lamp. Additionally, the incident light can be reflected and transmitted light from a sample. The spectrum of incident light can be in ultraviolet, visible, and infrared regions of the electromagnetic spectrum, and the incident light can be pulsed and continuous. The entrance optical elements (6) can be iris, objective, mirror, telescope, aperture, lens, polarizer, Glan-Thomson prism, quarter-wave plate, and half-wave plate. The focusing and guiding optical elements (2) can be a meta-lens, positive lens, Fresnel lens, spherical lens, cylindrical lens, dichroic mirror, concave mirror, convex mirror, fiber, diffractive optical element, and prism. Then the incident light beam passes to the transmission diffractive optical element (3). The diffractive optical elements (3) are positioned on the linear moving table in motion. The mechanisms that provide the movement of the linear moving table where the diffractive optical elements (3) are placed on can be four-bar linkage, slider-crank, Watt linear motion, Chebyshev linear motion, Chebyshev Lambda, and Robert linear motion mechanisms. The diffractive optical elements (3) can be fabricated from insulators, semiconductors, metals, polymers, and a combination of these materials. The incident light beam transmitted from the diffractive optical elements (3) reaches the focusing and guiding optical elements (2) again. The incident light beam reaching the focusing and guiding optical elements (2) is directed to the detector (4). The use of focusing and guiding optical elements (2) after diffractive optical elements (3) is additional equipment provided to further increase the wavelength resolution. Depending on the design, diffractive optical elements (3) take on the task of the equipment numbered 2 and 6. Depending on the light intensity and device dimensions, the focusing and guiding optical elements (2) and entrance optical elements may not be used. The detector (4) can be a photodetector operating in different spectra, avalanche photodetector, photomultiplier tube, CCD camera, CMOS camera, and line array photodiodes.

The components seen in FIG. 7 are the light beam from the light source (1), the entrance optical elements (6), the focusing and guiding optical elements (2), reflection diffractive optical elements placed on the linear moving table and designed for each wavelength (3) and a detector (4). The incident light beam can be the sunlight, laser, fiber laser, vertical-cavity surface-emitting laser (VCSEL), LED, bulb, lamp. Additionally, the incident light can be reflected and transmitted light from a sample. The spectrum of incident light can be in ultraviolet, visible, and infrared regions of the electromagnetic spectrum, and the incident light can be pulsed and continuous. The entrance optical elements (6) can be iris, objective, mirror, telescope, aperture, lens, polarizer, Glan-Thomson prism, quarter-wave plate, and half-wave plate. The focusing and guiding optical elements (2) can be a meta-lens, positive lens, Fresnel lens, spherical lens, cylindrical lens, dichroic mirror, concave mirror, convex mirror, fiber, diffractive optical element, and prism. Then the incident light beam reflects from the reflective diffractive optical element (3). The diffractive optical elements (3) are positioned on the linear moving table in motion. The mechanisms that provide the movement of the linear moving table where the diffractive optical elements (3) are placed on can be four-bar linkage, slider-crank, Watt linear motion, Chebyshev linear motion, Chebyshev Lambda, and Robert linear motion mechanisms. The diffractive optical elements (3) can be fabricated from metals, semiconductors, insulators, polymers, and a combination of these materials. The incident light beam reflected from the diffractive optical elements (3) reaches the focusing and guiding optical elements (2) again. The incident light beam reaching the focusing and guiding optical elements is directed to the detector (4). The use of focusing and guiding optical elements (2) after diffractive optical elements (3) is additional equipment provided to further increase in spectral resolution. Depending on the design, diffractive optical elements (3) take on the task of the equipment numbered 2 and 6. Depending on the light intensity and device dimensions, the focusing and guiding optical elements (2) and entrance optical elements (6) may not be used. The detector (4) can be a photodetector operating in different spectra, avalanche photodetector, photomultiplier tube, CCD camera, CMOS camera, and line array photodiodes.

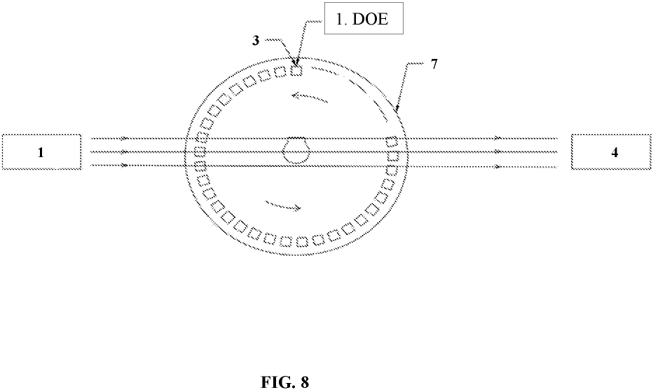

The components seen in FIG. 8 are the light beam from the light source (1), the transmission diffractive optical elements (3) placed on the rotating table and designed for each wavelength and the detector (4). The detector (4) used here is a camera. The incident light beam can be the sunlight, laser, fiber laser, vertical-cavity surface-emitting laser (VCSEL), LED, bulb, lamp. Additionally, the incident light can be reflected and transmitted light from a sample. The spectrum of incident light can be in ultraviolet, visible, and infrared regions of the electromagnetic spectrum, and the incident light can be pulsed and continuous. Then the incident light beam passes to the transmission diffractive optical element (3). The diffractive optical elements (3) are positioned on the rotating table in motion. The mechanisms that provide the movement of the rotating table where the diffractive optical elements (3) are placed can be four-bar linkage and slider-crank mechanisms. Also, rotational movement can be provided by a step motor and piezo. The diffractive optical elements (3) can be fabricated from insulators, semiconductors, metals, polymers, and a combination of these materials. The incident light beam transmitted through the diffractive optical elements (3) reaches the camera (4). The camera (4) can be a CCD camera, CMOS camera, phone camera, and computer camera.

The wave number restricting spectral resolution in conventional spectrometers is eliminated by the diffractive optical element designed for each wavelength with the above designs. A high-resolution spectrometer requires more frequent steps at the wavelength, and diffractive optical elements are designed according to this number of steps. More diffractive optical elements are needed to achieve high resolution. In addition, optical guider and collector equipment is not needed after diffractive optical elements for the installation of compact optical spectrometer.

1. An optical spectrometer high spectral resolution, comprising:
a light source forming the light beam,
entrance optical elements through which the light beam passes and which make the light beam suitable for proper operation of the spectrometer,
focusing and guiding optical elements, which are used to focus and direct the light beam,
diffractive optical elements designed for each wavelength, reflecting or transmitting the light beam coming out from the focusing and guiding optical element,
a detector where the light beam reflected from or transmitted through the diffractive optical elements reaches,
a data collector and controller that collects data and controls the system
a moving part on which the diffractive optical elements are positioned.

2. The optical spectrometer according to claim 1, wherein the entrance optical elements comprises iris, objective, mirror, telescope, aperture, lens, polarizer, Glan-Thomson prism, quarter-wave plate, and half-wave plate.

3. The optical spectrometer according to claim 1, wherein the diffractive optical elements are fabricated from metals, semiconductors, insulators, polymers, or a combination of these materials.

4. The optical spectrometer according to claim 1, wherein the moving part is a rotating table.

5. The optical spectrometer according to claim 1, wherein the moving part is a linear moving table.

6. The optical spectrometer according to claim 1, wherein the detector is a photodetector, avalanche photodetector, photomultiplier tube, CCD camera, CMOS camera, or line array photodiodes.

7. The optical spectrometer according to claim 1, wherein the focusing and guiding optical elements are a meta-lens, positive lens, Fresnel lens, spherical lens, cylindrical lens, dichroic mirror, concave mirror, convex mirror, fiber optic cable, diffractive optical element, or prism.

8. The optical spectrometer according to claim 4, wherein mechanisms of the moving part include a four-bar linkage and a slider crank.

9. The optical spectrometer according to claim 4, wherein driving force of the rotational movement of the moving part includes a step motor and a piezo.

10. The optical spectrometer according to claim 5, wherein the-mechanisms that provide the movement of the moving part are four-bar linkage, slider-crank, Watt linear motion, Chebyshev linear motion, Chebyshev Lambda, or Robert linear motion mechanisms.
